(19) United States
(12) Patent Application Publication
(10) Pub. No.: US 2002/0199083 A1
(43) Pub. Date: Dec. 26, 2002

(54) High code-density microcontroller architecture with changeable instruction formats

(75) Inventors: Min-Fu Kao, Taipei (TW); Hwan-Rei Lee, Hsinchu City (TW)

Correspondence Address: BACON & THOMAS, PLLC, 625 SLATERS LANE, FOURTH FLOOR, ALEXANDRIA, VA, 22314

(73) Assignee: Sunplus Technology Co.,Ltd, Hsin-Chu (TW)

(21) Appl. No.: 09/930,976

(22) Filed: Aug. 17, 2001

(30) Foreign Application Priority Data
Jun. 20, 2001 (TW) 90115018

(51) Int. Cl. G06F 9/30

(52) U.S. Cl. 712/209; 712/210

(57) ABSTRACT

A high code-density microcontroller architecture with changeable instruction formats has a memory for storing compressed instructions each including a group prefix and at least one index. An instruction decompressor is provided for decompressing the compressed instructions to be executed into original instructions. The instruction decompressor includes a plurality of instruction group decoding tables, each being stored with the original instructions of a predetermined type. One instruction group decoding table is selected based on the group prefix of the compressed instruction for searching the corresponding original instruction therein by the index of the compressed instruction.

### BACKGROUND OF THE INVENTION

1. Field of the Invention

The present invention relates to microcontroller architecture in an embedded system and, more particularly, to a high code-density microcontroller architecture with changeable instruction formats.

2. Description of Related Art

In an embedded system, a high integration is a very important feature. Also, as the function of the embedded system is getting complicated, the capacity of the read-only memory (ROM) is increased. However, such a large-capacity ROM may significantly increase system cost, and further, become a bottleneck for accessing instructions, thus adversely affecting the system performance.

To eliminate the above problems, one should think how to decrease ROM size without sacrificing system performance and efficiency. Currently, there are two approaches proposed: one is to provide a compact subset of the original instruction set architecture (ISA) and the other one is to use the instruction block oriented compression scheme.

As to the former approach, ARM Thumb and SGI MIPS16 are two typical examples, which are the compact subsets of ARM and MIPS respectively. Such an approach is widely employed in processing the instruction set whose original instruction length is 32-bit. By reducing the number of bits in each filed of the instruction to obtain the 16-bit instruction, an 16-bit instruction set, which is a compact subset of the original one, is obtained. In the case of MIPS, the instruction of MIPS has a 32-bit fixed length format and can be classified into the following three types: I-type (immediate), J-type (jump), and R-type (register-to-register). An I-type instruction is shown in FIG. 1, which includes an op-code field, a source register field, a target register field, and an immediate value field. Under some pre-regulated conditions, a corresponding compact subset of I-type instruction, as denoted by MIPS16, is obtained by reducing the length of each field.

In the same manner, it is able to obtain a compact subset of MIPS (e.g., MIPS16). As such, the program code represented by MIPS16 has a reduced length. A block diagram of hardware structure of MIPS16 is shown in FIG. 2, wherein a MIPS16 decompression logic 22 is coupled between an instruction cache 21 and a standard MIPS pipeline 23 for decompressing MIPS16 instructions fetched from the instruction cache 21 into MIPS instruction prior to feeding the same to the standard MIPS pipeline 23 for being executed.

The aforementioned approach is unsatisfactory for the following reasons: (1) It is not possible for a compact subset of instruction set to exist independently. On the contrary, it is required to coexist with the original instruction set, resulting in a reduction of flexibility. (2) The number of original program instructions is increased since the compact subset of instruction set is also a subset of instruction. As a result, the compression efficiency is lowered. (3) The use of the MIPS16 decompression logic 22 may form a critical path in the original pipeline scheme, thus lowering the operating speed. (4) No optimization of compression is performed with respect to different applications. Thus, an advantageous customization is not provided.

As to the second approach, IBM CodePack and Wolfe CCRP (compressed code RISC processor) are two typical examples, in which a modified Huffman coding is employed as a compression algorithm for achieving an effective decompression during execution. An instruction cache line is served as a compression unit for storing compressed programs in main memory. Instructions after decompressed are stored in instruction cache.

A block diagram of memory structure of CCRP is shown in FIG. 3. As stated above, the compressed program code is stored in instruction memory 31 and the decompressed instructions are stored in instruction cache 32 respectively. Furthermore, cache refill engine 33 is provided to decompress instructions. In executing program, if a cache hit is occurred, the central processing unit (CPU) 34 may directly fetch the uncompressed instructions and execute the same. However, if a cache miss is occurred, the cache refill engine 33 may fetch compressed instructions from instruction memory 31 for decompression. The decompressed instructions are then stored in the instruction cache 33. Finally, CPU 34 fetches the stored instructions from instruction cache 32 for executing the same. There are also provided line address table (LAT) 311 and cache line address lookaside buffer (CLB) 35 in the memory structure of CCRP as shown in FIG. 3. The LAT 311 is created by a compressing software during compression period. The LAT 311 can map address of uncompressed instruction block to that of compressed instruction block for solving the problem of different branch target addresses caused by the control transfer instruction. The CLB 35 is used in conjunction with LAT 311 for decreasing the time of instruction refill when a cache miss is occurred.

This approach is still unsatisfactory for the following reasons: (1) The size of the LAT 311 increases as the size of the instruction block decreases. (2) In microcontroller or low-end embedded applications, the instruction cache does not exist. Thus, this approach is not applicable. (3) 110 No optimization of compression is performed with respect to different applications. Thus, an advantageous customization is not provided.

Therefore, the conventional skills to reduce the size of the program code still can not meet the actual requirement. Accordingly, it is desirable to provide a novel architecture for mitigating and/or obviating the aforementioned problems.

### SUMMARY OF THE INVENTION

The object of the present invention is to provide a high code-density microcontroller architecture with changeable instruction formats for reducing the capacity requirement of the ROM and the system cost without degrading system performance and lowering the efficiency.

To achieve the object, the microcontroller architecture in accordance with the present invention comprises: a memory for storing compressed instructions each having a group prefix followed by at least one index; a compressed instruction buffer for storing and buffering the instructions fetched from the memory; a next address logic for selectively accessing an instruction from the memory and directly sending out a next instruction in the compressed instruction buffer directly; and an instruction decompressor for decompressing the compressed instruction sent from the compressed instruction buffer into an original instruction, wherein the instruction decompressor has a plurality of instruction group decoding tables, each being stored with the original instructions of a predetermined type, and the instruction decompressor selects one of the instruction group decoding tables based on the group prefix of the compressed instruction for searching a corresponding original instruction therein by the index of the compressed instruction.

Other objects, advantages, and novel features of the invention will become more apparent from the detailed description when taken in conjunction with the accompanying drawings.

### BRIEF DESCRIPTION OF THE DRAWINGS

FIG. 1 is a schematic diagram showing a mapping relationship of conventional MIPS and MIPS16 instructions;

FIG. 2 is a block diagram of a conventional MIPS16 system;

FIG. 3 is a block diagram of the memory structure of a conventional CCRP system;

FIG. 4 schematically illustrates an approach for designing an embedded system using the high code-density microcontroller architecture with changeable instruction formats in accordance with the present invention;

FIG. 5 schematically illustrates a relationship between custom instructions and a decoding table in accordance with the present invention;

FIG. 6 is a block diagram of microcontroller architecture in accordance with the present invention; and

FIG. 7 is a block diagram of instruction decompressor of the microcontroller architecture in accordance with the present invention.

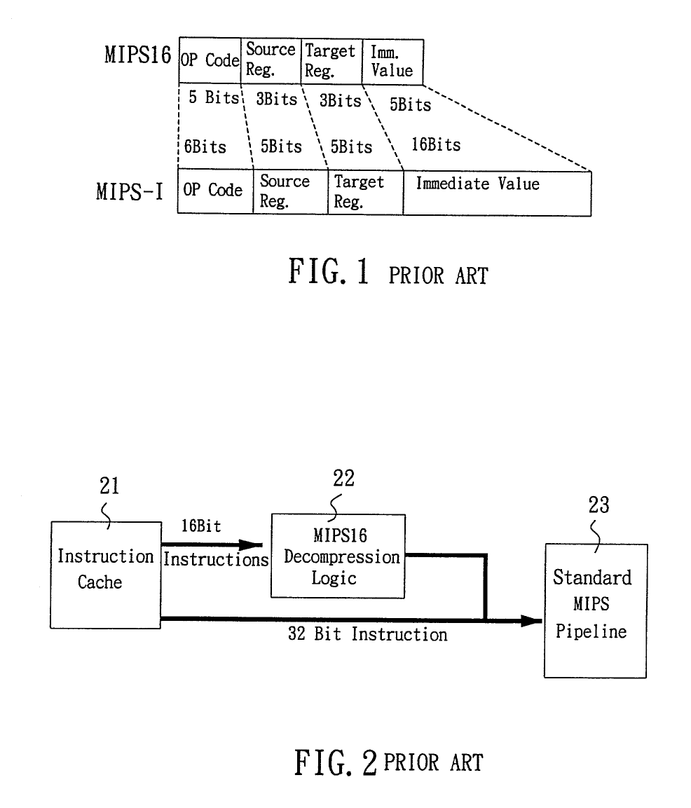

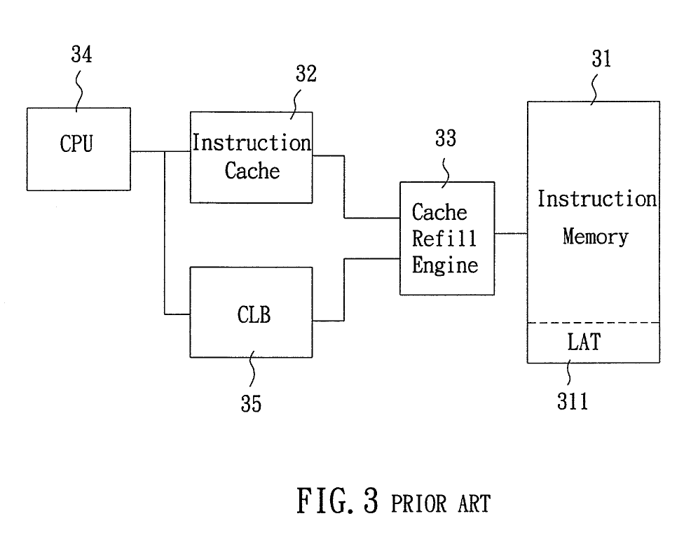

### DETAILED DESCRIPTION OF THE PREFERRED EMBODIMENT

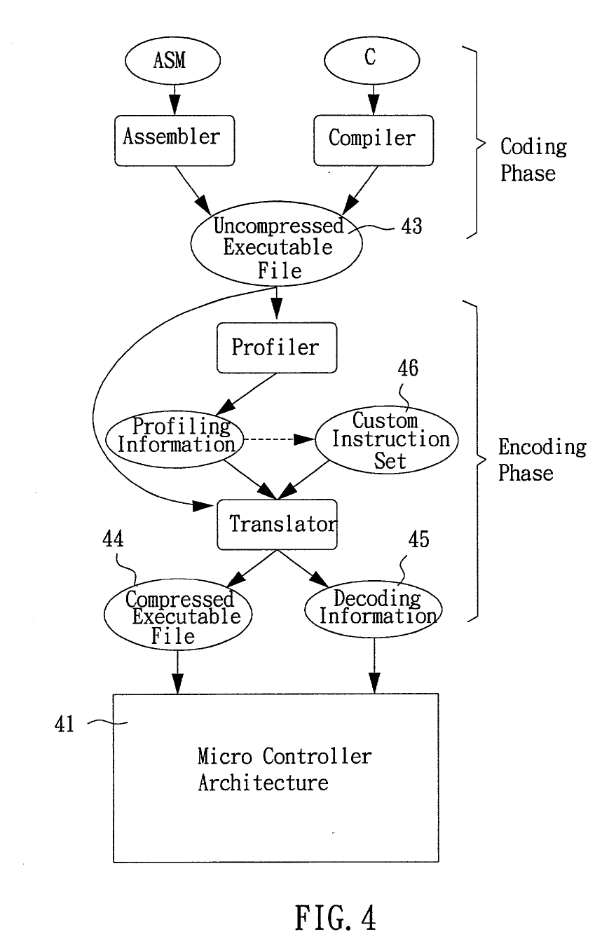

With reference to FIG. 4, there is shown an approach for designing an embedded system using the high code-density microcontroller architecture with changeable instruction formats in accordance with the present invention. The design is based on the features as follows:

(1) In embedded system, the function of application program is specific and unchangeable. That is, in a product development phase, the specification and characteristic of the program are fixed.

(2) Generally, in the program code generated by either the assembler or the compiler, only a small portion of usable instructions is involved.

Therefore, as shown in FIG. 4, in the coding phase, this approach still utilizes assembly language or high level language (e.g., C language), as the same in the conventional skill, to develop application programs and obtain uncompressed executable files 43. Then, in encoding phase, a suitable software compressing tool, such as Profiler or Translator, is used to obtain the compressed executable file 44 constituted by the custom instruction set 46, and decoding information 45 for being applied to design the hardware of the microcontroller architecture.

The aforementioned custom instruction set 46 can be classified as a variety of instruction groups based on the features of the original instructions (e.g., occurrence frequency and instruction format). Then, the instructions in such instructions groups are represented in a more compact manner for achieving the effect of compressing instructions. For example, the instruction that is used more frequently is represented by a number with smaller bits. Such a new custom instruction is an index of a certain table. Thus, the microcontroller architecture 41 may find a corresponding original instruction or directly get the decoded control signals from the table by performing table lookup operation.

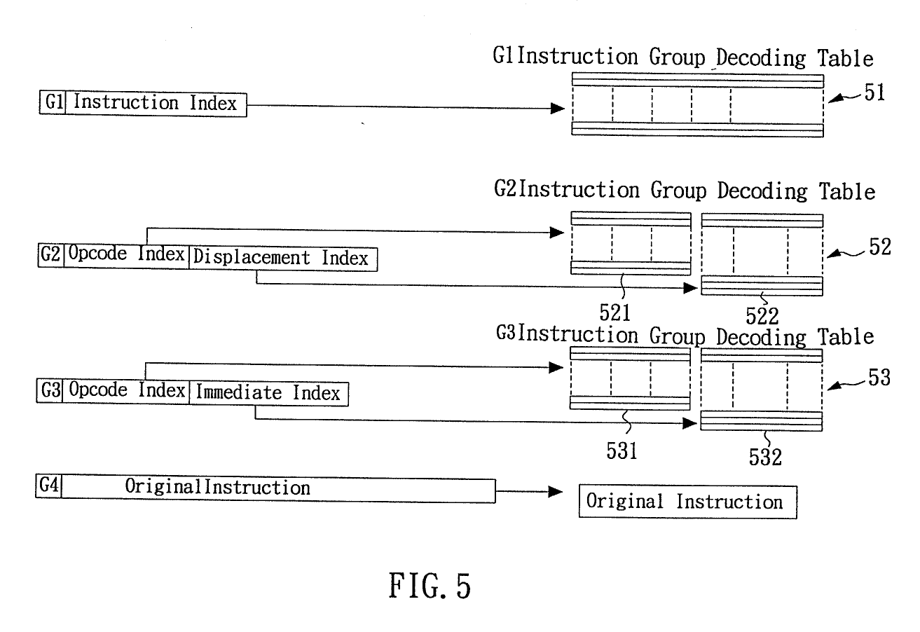

With reference to FIG. 5, there is shown an example for illustrating a relationship between the custom instructions and a decoding table of the decoding information 45 according to the invention. In this example, it is assumed that the original instruction set is classified as the following four instruction groups:

(G1) R-Group (Instruction without immediate): This type of instruction group consists of simple instructions which are neither for control transfer nor having immediate values;

(G2) C-Group (control transfer): This type of instruction group consists of instructions for control transfer, which, in general, have branch target address fields.

(G3) I-Group (instruction with immediate): This type of instruction group consists of instructions with immediate values but not for control transfer.

(G4) M-Group (Miscellaneous instruction): This type of instruction group refers to the instructions that cannot be classified as G1-G3 types.

In the case of G1 type instruction, the corresponding custom instruction consists of a group prefix G1 followed by an instruction index, wherein instruction index is used to search the corresponding G1 instruction group decoding table 51 which is stored with the corresponding original instructions.

In the case of G2 instruction, the corresponding custom instruction consists of a group prefix G2 followed by an op-code index representing a branch condition code, and a displacement index representing a branch target address, wherein the two indices are used to search two different sub-tables 521 and 522 of the G2 instruction group decoding table 52. The sub-table 521 is stored with the branch condition codes of the corresponding original instructions. The sub-table 522 is stored with the branch target addresses of the corresponding original instructions. Hence, various information may be obtained by mapping for completing instruction decoding.

In the case of G3 instruction, the corresponding custom instruction consists of a group prefix G3 followed by an op-code index representing operation code, and an immediate index representing an immediate value, wherein the two indices are used to search sub-tables 531 and 532 of the G3 instruction group decoding table 53. The sub-table 531 is stored with the operation codes of the corresponding original instructions. The sub-table 532 is stored with the immediate values of the corresponding original instructions. Hence, various information may be obtained by mapping for completing instruction decoding.

In the case of G4 instruction, there is no decoding table required for decompressing instructions into the original instruction formats since G4 instruction is uncompressed. Hence, the corresponding custom instruction simply consists of a group prefix G4 followed by the original instruction.

The group prefix G1˜G4 can be encoded to have a fixed length, e.g., 2 bits. Alternatively, the group prefix G1˜G4 can also be encoded to have a variable length. For example, based on the Huffman coding scheme, the group prefix of the frequently used instructions is assigned with a shorter code.

The above classification for G1˜G4 type instruction groups is only an exemplary embodiment. In practical application, the classified number of instruction groups, the format and length of the group prefix, and the length of the custom instruction can be determined based on the characteristics of the application program, the hardware, and profiling information. Hence, optimization is performed with respect to different applications. Thus an advantageous customization is provided. One of a number of limitations is that the length of each of custom instruction is required to be less than that of original instruction so as to achieve the compressing effect.

The compressed custom instructions are executed by the microcontroller architecture 41 in accordance with the present invention.

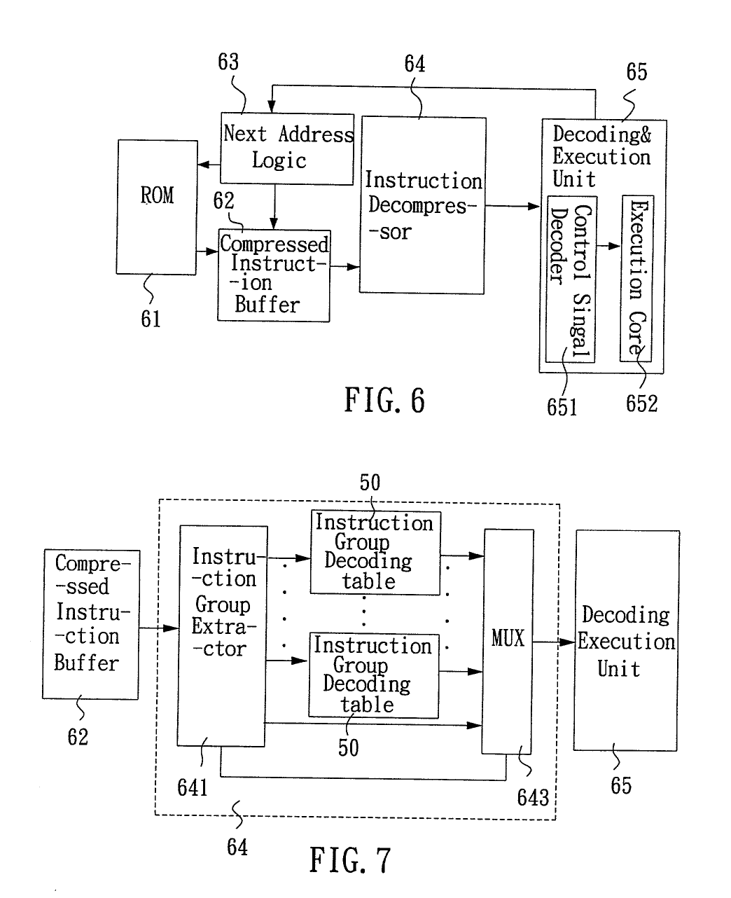

FIG. 6 is a block diagram of the microcontroller architecture 41, which comprises a memory 61, an compressed instruction buffer 62, a next address logic 63, an instruction decompressor 64, and a decoding and execution unit 65. The memory 61 is provided to store the compressed program code. Preferably, the memory 61 is a ROM since there is no need to modify program code in an embedded system.

The compressed instruction buffer 62 is provided to store and buffer the data blocks from memory 61 when the microcontroller is fetching instructions. Because the length of the custom instruction is less than that of the original instruction, the compressed instruction buffer 62 may contain several compressed instructions.

The next address logic 63 is provided to determine, based on the status of the microcontroller, whether to fetch instructions from memory 61 or to directly send out the next instruction in the compressed instruction buffer 62.

The instruction decompressor 64 is provided to decompress the compressed instructions sent from the compressed instruction buffer 62 into the original instructions, which are in turn sent to the decoding and execution unit 65. In the decoding and execution unit 65, there are provided a control signal decoder 651 for decoding the original instructions into hardware control signals, and an execution core 652 controlled by the control signal decoder 651 for performing corresponding processes. The control signal decoder 651 and the execution core 652 are well known in typical microcontroller, and thus a detailed description is deemed unnecessary.

With use of the compressed instruction buffer 62 and the next address logic 63, the microcontroller can correctly fetch the desired instructions to be executed. The process is depicted by the following steps:

(1) The next address logic 63 obtains the address of the next instruction to be fetched based on the current status of the microcontroller.

(2) The compressed instruction buffer 62 notifies the next address logic 63 of information containing the number of instructions. Hence, the next address logic 63 can determine whether the instruction to be executed is in the compressed instruction buffer 62.

(3) If the instruction to be performed is not in the compressed instruction buffer 62, the next address logic 63 will send out the address of the instruction to be fetched, so as to perform a fetch operation for the next instruction on the memory 61. The process then jumps to step (5).

(4) If the instruction to be executed is in the compressed instruction buffer 62, the instruction compression buffer 62 will select a correct instruction from the fetched instruction block and send the same to the instruction decompressor 64 for performing a decompression. The process then jumps to step (1).

(5) The content of the instruction block fetched from the memory 61 is stored and aligned in the internal buffer of the compressed instruction buffer 62.

(6) The length of the compressed instruction is determined based on the group prefix of instruction.

(7) Hence, the compressed instruction buffer 62 can be aware of the number of compressed instructions in the instruction block and the boundary of each compressed instruction. This information is sent to the next address logic 63 via control signals.

The compressed instruction fetched as described above is decompressed into the original instruction by the instruction decompressor 64. FIG. 7 is a block diagram of the instruction decompressor 64, which includes an instruction group extractor 641, a plurality of instruction group decoding tables 50, and a multiplexer 643. The instruction group extractor 641 is provided to extract the compressed instructions sent from the compressed instruction buffer 62, so as to control the multiplexer 643, based on the group prefix of the compressed instruction, to select one of the instruction group decoding tables 50, and determine a corresponding original instruction by using the value of the index field of the compressed instruction to search the selected instruction group decoding table 50. This original instruction is then sent to the decoding and execution unit 65 from the multiplexer 643 for being executed.

The information of the instruction group decoding tables 50 can be obtained from the software tool Translator. These tables may be implemented by programmable logic arrays (PLAs), and are programmed in the mass production phase. Moreover, because the new custom instructions of the present invention have been classified based on the instruction characteristics, the instruction group decoding table 50 is typically comprised of a number of small sub-tables rather than a single large one. Hence, a decompression process by performing a table lookup may neither cause an adverse effect on hardware nor increase the access time.

In view of the foregoing, the present invention is designed to collect characteristics of original instructions in application programs for customizing a new instruction set architecture in the product development phase. As a result, the size of the program code is reduced. The new custom instructions represent the index values of a certain table. A decoding circuit may be employed to find corresponding original instructions by performing a table lookup. Thus, in comparison with the conventional skills, the present invention is provided with the following advantages:

(1) Because of using changeable instruction formats and one-to-one instruction compression technique, it is suitable for low-end embedded system such as microcontroller.

(2) It is able to perform an optimization for instruction set with respect to different embedded applications. Thus an advantageous customization is provided.

(3) An increase of program code density and fewer program code are the result of the above optimization and customization, thus lowering the demand for high-capacity ROM.

(4) The instruction fetch-utilization rate is increased as the program code density is increased. As a result, memory bus traffic is lowered and the power consumption of the system is reduced.

(5) A software/hardware co-design is implemented in product development phase, thereby increasing the cost-effectiveness.

Although the present invention has been explained in relation to its preferred embodiment, it is to be understood that many other possible modifications and variations can be made without departing from the spirit and scope of the invention as hereinafter claimed.

What is claimed is:

1. A high code-density microcontroller architecture with changeable instruction formats, comprising:
a memory for storing compressed instructions each having a group prefix followed by at least one index;
a compressed instruction buffer for storing and buffering the instructions fetched from the memory;
a next address logic for accessing an instruction from the memory or sending out a next instruction in the compressed instruction buffer directly; and
an instruction decompressor for decompressing the compressed instruction sent from the compressed instruction buffer into an original instruction,
wherein the instruction decompressor has a plurality of instruction group decoding tables, each being stored with the original instructions of a predetermined type, and the instruction decompressor selects one of the instruction group decoding tables based on the group prefix of the compressed instruction for searching a corresponding original instruction therein by the index of the compressed instruction.

2. The architecture as claimed in claim 1, further comprising a decoding and execution unit including a control signal decoder for decoding the original instructions into control signals and an execution core controlled by the control signal decoder for performing corresponding processes.

3. The architecture as claimed in claim 1, wherein the instruction decompressor further includes a multiplexer and instruction group extractor for extracting the compressed instruction sent from the compressed instruction buffer, controlling the multiplexer to select one of the instruction group decoding tables based on the group prefix of the compressed instruction, and searching the corresponding original instruction therein by the index of the compressed instruction for being outputted by the multiplexer to the decoding and execution unit to be executed.

4. The architecture as claimed in claim 1, wherein the memory is a read-only memory (ROM).

5. The architecture as claimed in claim 1, wherein the compressed instruction in the memory consists of a first group prefix followed by an instruction index for searching a first instruction group decoding table stored with the corresponding original instructions.

6. The architecture as claimed in claim 1, wherein the compressed instruction in the memory consists of a second group prefix followed by an op-code index representing a branch condition code, and a displacement index representing a branch target address; the op-code and the displacement indices are used to search a second instruction group decoding table including a first sub-table and a second sub-table, respectively, the first sub-table being stored with the branch condition codes of the corresponding original instructions, the second sub-table being stored with the branch target addresses of the corresponding original instructions.

7. The architecture as claimed in claim 1, wherein the compressed instruction in the memory consists of a third group prefix followed by an op-code index representing an operation code, and an immediate index representing an immediate value; the op-code and the immediate indices are used to search a third sub-decoding table including a third sub-table and a fourth sub-table, respectively, the third sub-table being stored with the operation codes of the corresponding original instructions, the fourth sub-table being stored with the immediate values of the corresponding original instructions.

8. The architecture as claimed in claim 1, wherein the memory further comprises program codes each consisting of a fourth group prefix followed by an original instruction.

9. The architecture as claimed in claim 1, wherein the group prefix is encoded to have a fixed length.

10. The architecture as claimed in claim 1, wherein the group prefix is encoded to have a variable length in such a manner that the group prefix of a frequently used instruction is assigned with a relatively short code.
